(19) United States
(12) Patent Application Publication
(10) Pub. No.: US 2015/0296117 A1
(43) Pub. Date: Oct. 15, 2015

(54) SYSTEMS AND METHODS FOR FACILITATING EXAMINATION OF A VEHICLE

(71) Applicant: Olden B. Johnson, Acworth, GA (US)

(72) Inventor: Olden B. Johnson, Acworth, GA (US)

(21) Appl. No.: 14/684,201

(22) Filed: Apr. 10, 2015

Related U.S. Application Data
(60) Provisional application No. 61/977,725, filed on Apr. 10, 2014.

(51) Int. Cl. H04N 5/232; H04M 1/725

(52) U.S. Cl. CPC H04N 5/23203; H04M 1/72505

(57) ABSTRACT

Systems and methods are presented herein for facilitating traffic ticketing from inside of a law enforcement vehicle. An apparatus with an extendible elongate member is used in one embodiment. A distal end of the elongate member may include a communications unit capable of video, audio, lighting, and assisting with remote smell detection. The communications unit may also receive physical driver credentials in one embodiment. In another embodiment, the communications unit may dispense a traffic ticket.

### CROSS REFERENCE TO RELATED APPLICATION

This non-provisional patent application claims the benefit of priority to provisional application No. 61/977,725 (“Systems and Methods for Facilitating Examination of a Vehicle”), filed Apr. 10, 2014, which is hereby incorporated by reference in its entirety.

### FIELD OF THE EMBODIMENTS

The embodiments relate generally to systems and methods for increased security for examining a vehicle, and more specifically, to an apparatus that may allow law enforcement to perform ticketing without having to get out of the police car.

### BACKGROUND

Every year, police officers die trying to make routine traffic stops. Stepping outside the police vehicle exposes them to the risk of being hit by other vehicles. In addition, the occupants of the pulled-over vehicle also can be a threat to the police officer. In fact, the inventor of the present invention was motivated in part by the story of an officer who was shot and killed by the people he had pulled over for speeding.

Under current methods, a police officer will pull over a car by driving behind it and using the light-bar and/or siren on the car to indicate that the driver should pull over. Once pulled over, the police officer must get out of his vehicle and approach the offender's vehicle. There may not be much room off of the main roadway, so the police officer is exposed to risk of injury.

Additionally, the police officer must approach the offender at the driver's side window. The police officer cannot see what is happening the vehicle without doing so. Usually, it is only by physically approaching the offender that the police officer is able to ascertain whether the offender is under the influence of alcohol or other drugs. And the police officer must physically receive the driver's license and registration, which leaves the police officer vulnerable to physical attack.

Attempts to improve this situation have fallen short. For example, U.S. Pat. No. 7,309,080 describes an extendable arm for a motor vehicle, but it is permanently attached to the vehicle and not flexible enough in implementation to allow for practical use. It is also subject to damage and exposure to the outside environment of the car. Additionally, it does not allow the officer to make all of the checks he would normally make at a traffic stop.

Therefore, current systems and methods for handling traffic stops do not afford police with enough safety from other passing vehicles or from the dangers of potential criminals in the vehicle that has been pulled over.

Therefore, a need exists for improved systems and methods for facilitating traffic ticketing.

### SUMMARY

Embodiments described herein include systems and methods for facilitating traffic ticketing. These systems and methods may include an apparatus with a telescoping member that allows the police officer to view and converse with a driver or otherwise examine a pulled-over or suspicious vehicle, detect the presence of marijuana or alcohol, and receive driver information without physically approaching the driver.

In one embodiment, the extendable apparatus includes a base member that can be positioned on top of a door of a law enforcement vehicle when the window is rolled down, or, alternatively, on the arm of the law enforcement officer.

An elongate extendable member may be coupled to the base member, the elongate extendable member having at least two sections, a distal end, and a proximal end. The at least two sections may perform a telescoping action that allows the elongate extendable member to extend towards the driver's side door of a pulled-over vehicle.

A communication unit may be coupled to the distal end of the elongate extendible member. This communication unit may include a camera element, an audio element, a lighting element, and a smell detection unit. In one embodiment, the camera element may allow the officer to view the driver of the pulled-over vehicle by receiving video transmission at the base member. It may also allow the officer to record the driver's actions during the ticketing process. The audio element may allow the officer to converse with the driver. The lighting element may allow the officer to shine a light in the driver's face, both to better see the driver with and to witness the driver's reaction. Finally, the smell detection unit may allow the officer to determine if alcohol or marijuana might be present. This can occur by either utilizing known Breathalyzer technologies at the communication unit, or, in another embodiment, via a fan that sucks air from the distal end of the extendible member down to the proximal end where the officer can smell it.

The extendable apparatus may also include a pivoting handle grip that swings into place for bracing the extendable ticketing apparatus on a human arm, and retracts for placing the extendable ticketing apparatus on a car door. An officer may use the extendable apparatus to examine a pulled-over and/or suspicious vehicle, such as a vehicle believed to be involved in a crime that is found parked somewhere.

In a further embodiment, the elongate extendable member is at least partially made of a lightweight material, such as a thermoplastic that includes a mix of glass and polymer fiber. This may allow the apparatus to weigh little enough to be maneuvered by the officer. In addition, its light weight may reduce the chance of serious harm if a passing vehicle hits the extendible member. For example, in one embodiment the extendible member will come apart upon receiving an impact force of greater than 60 lbs per square inch, yet still stand up to normal wind situations and elements, such as rain or snow.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIGS. 1A and 1B are exemplary illustrations of an extendable apparatus, in accordance with an embodiment;

FIG. 2 is an exemplary diagram of a computer system, in accordance with an embodiment;

FIG. 3 is an exemplary illustration of an extendable apparatus, in accordance with an embodiment;

FIG. 4 is an exemplary illustration of an end probe of an extendable apparatus, in accordance with an embodiment;

FIG. 5 is an exemplary illustration of an end probe of an extendable apparatus, in accordance with an embodiment;

FIG. 6 is a further exemplary flow chart, in accordance with an embodiment; and

FIG. 7 is an exemplary flow chart, in accordance with an embodiment.

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

In one embodiment, an extendable apparatus may allow a law enforcement officer to perform traffic ticketing without leaving his vehicle. For example, the officer may roll down the window and place the apparatus on the door such that it straddles the top of the door, and use controls on the apparatus or elsewhere to cause a member to extend until it reaches the driver's side window. A distal end of the extending member may include a camera element, an audio element, a lighting element, a smell detection element, and an object carrying member. The camera element may detect the presence of the driver's side window or window opening and cause the extension rate to slow. Once the camera is in view of the driver's face, the light element may shine at the driver, allowing the officer to both see the driver and the driver's reaction to the light. The officer may converse with the driver via the audio element, may detect the presence of alcohol or marijuana via the smell detection element, and may receive the driver's license and registration via the object carrying member. In one embodiment, the object carrying member can also be used to dispense the ticket to the driver. In another embodiment, a printer element prints a ticket at the driver's window.

In one embodiment, the extendable member includes a first camera element at the distal end, wherein the first camera element substantially faces to the right such that it will point at the driver of the pulled over vehicle when extended from a law enforcement vehicle behind the pulled-over vehicle. In another embodiment, the camera element is attached to a base element that can swivel, such that the officer may control the direction of the camera. For example, the camera may be swiveled 180 degrees to point left, allowing an officer to use the extendable apparatus from in front of the pulled-over vehicle.

The camera element may also include a downward-facing camera that detects painted lane lines in an attempt to keep the extendable member from telescoping out into traffic.

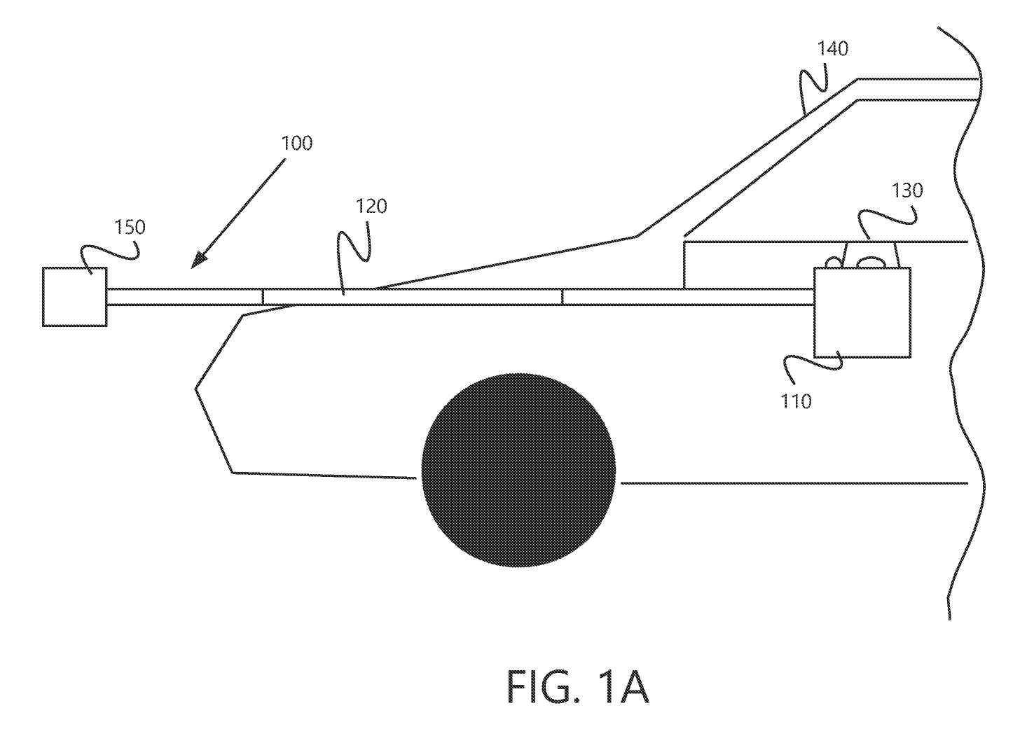

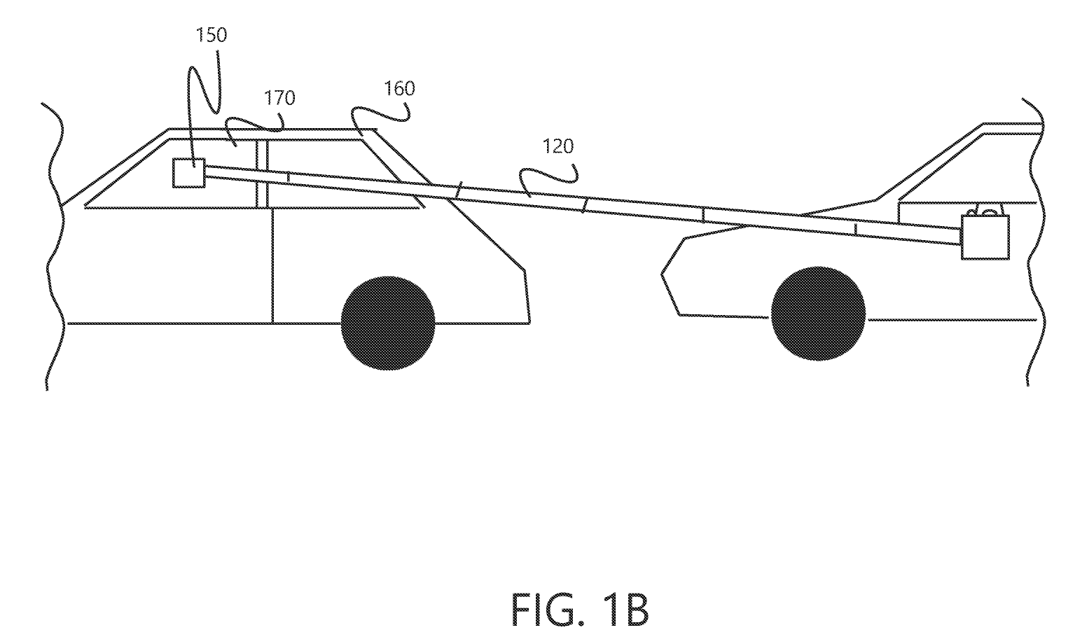

Turning to FIG. 1A, an exemplary illustration of an extendable apparatus 100 is shown. The extendable apparatus may have a base member 110 coupled to an elongate extendable member 120. In this example, the base member 110 is placed over the top of the door in the window opening 130 of a police car 140. The base member may straddle both sides of the door 130 to keep positioning during use. However, the base member 130 alternatively may be placed on the arm of an officer to provide additional flexibility in directing the elongate extendible member 120.

The base member 110 may include a battery pack, such as a lithium ion battery pack, which may be rechargeable by plugging the base member into an electrical outlet, USB outlet from a laptop, or a vehicle cigarette lighter. The battery pack may be used to power the telescoping action of the extendable apparatus 100.

The base member 110 may also include at least one electric motor to effectuate the extension of the elongate extension member 120.

In another embodiment, the extendable member can swivel 180 degrees on base member 110, such that it can be pointed backwards without having to swivel the communications unit.

The base member 110 may also have controls placed on it, such as on the portion that is located within the car 140 in the example of FIG. 1. The controls may be used by a user, such as a police officer sitting within car 140, to extend and steer the elongate extendible member 120. The controls may include extending and contracting, raising and lowering, and some degree of left/right maneuvering in one embodiment.

The elongate extendible member 120 may have a distal end at communication unit 150 and a proximal end at base member 130. The extendible member 120 may extend by telescoping in one embodiment. For example, the extendible member 120 may be comprised of a plurality of sections that fit within one another, and are slidably coupled to allow for the telescoping. Known methods of telescoping may be incorporated.

In an embodiment, the sections are threaded such that an inner section may corkscrew out of an outer section. In another embodiment, the outer-most section may also be threaded on the outside such that it may corkscrew through a hole in the base member 110, allowing the elongate member 120 to be partially extended in each direction from the base member 110. In this way, while not in use the elongate member 120 may be stored along the length of the driver's side door of the vehicle, allowing a user (e.g., policeman) to open and shut the door without interference from the elongate member 120.

In one embodiment, the telescoping may be accomplished pneumatically. The base member 110 may include an air pump that forces air into a bladder inside the elongate extendible member 120. At the same time, a spool of wire may be released to unwind as the extendible member telescopes. Then, to retract the elongate extendible member 120, the spool of wire may be reeled back in via an electric motor and/or manually.

In another embodiment, a motorized spool of rigid wire may located within base member 110. A distal end of the wire may be coupled to the distal end of the extendible member 120. When the spool unwinds, it may cause the extendible member 120 to telescope outward, and when it winds, it may cause the extendible member 120 to retract.

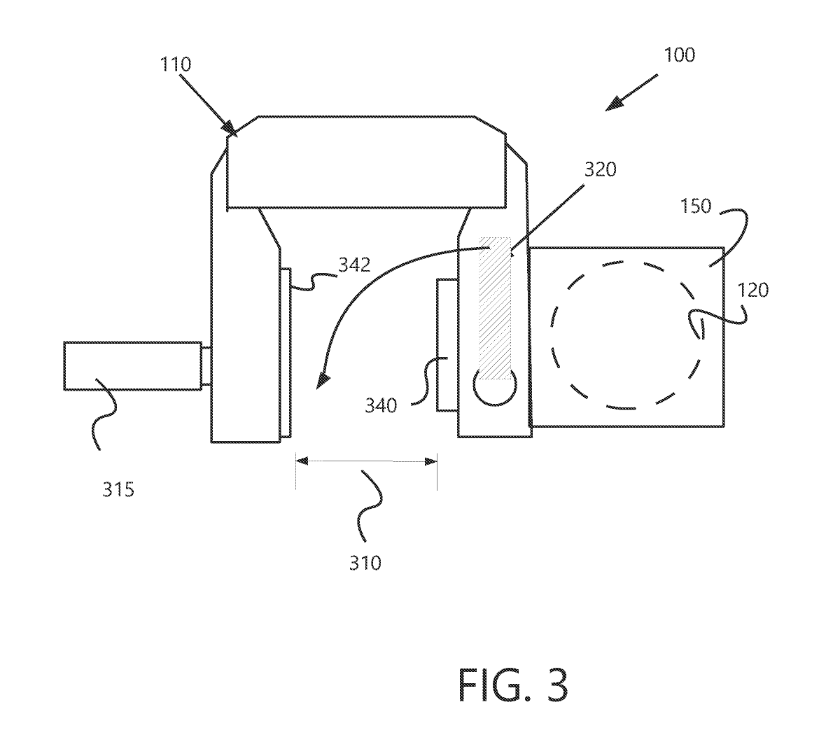

In still another embodiment, at least three such wires are included within the extendible member 120, each separated by roughly 120 degrees around the outside of a core lumen that extends down the center of the plurality of segments of the extendible member 120. When these wires move in unison, the extendible member 120 telescopes or retracts in a relatively linear fashion. However, by moving the wires at different rates and/or keeping one or more of the wires stationary, the extendible member 120 may be snaked upwards, downwards, left, and right. The spooling action of the multiple wires may be controlled with, for example, a joystick 315 on the inner side of the base member 110 (see, e.g., FIG. 3).

In yet another embodiment, two spools of tape are used instead of or in addition to the aforementioned wires. Each tape may be flexible in only one plane, such that if they are oriented perpendicular to one another, one of the tapes provides resistance to movement in either the X or Y directions.

In one embodiment, the widest diameter of the extendible member 120 is less than 4 inches. In another embodiment, the extendible member 120 can extend up to 30 feet.

The extendible member 120 may be made out of lightweight rigid material. In one embodiment, this includes lightweight thermoplastic containing a mix of glass and polymer fiber. In addition, each segment of the extendible member 120 may include a thin aluminum and/or steel strip, such as GALVALUME™, to reinforce the segment against flexing in the X and Y directions. In another embodiment, the thin strip is comprised of titanium. The thin strip may be less than one centimeter thick in one embodiment.

The segments may be slidably coupled, with a catch present once the end of a first segment reaches the end of a second adjacent segment. In one embodiment, the catch may give way, allowing the segments to come apart, under a force of at least 60 pounds per square inch. This may help prevent accident or injury if a passing motorist were to collide with the extendible member 120.

Alternatively, the elongate extendible member 120 may be extended and controlled as described in U.S. Pat. No. 7,309,080, which is incorporated by reference.

FIG. 1B depicts the extendible member 120 more fully extended so that the communication unit 150 is in position at the driver's side window 170 of the pulled-over vehicle 160. The communication unit 150 may include a camera element, an audio element, a lighting element, and a smell detection unit in one embodiment.

In one embodiment, as the extendible member 120 is extending, the camera unit monitors for the driver's side window. It may look for a space between the color of the car's exterior, indicating a window opening. It may also look for its own reflection in one embodiment. Upon recognizing that it is within a window space, it may cause the computer system of the base member to decrease the speed at which the communication unit 150 is maneuvered. The camera unit may also be used by the computer system to monitor for lane lines on the road to make sure that the extendible member 120 does not extend out into traffic lanes of a roadway. If the extendible member 120 gets too close to the lane line, automatic retraction may occur in one embodiment.

In another embodiment, the apparatus 100 monitors how far off center the telescoping extendable member 120 becomes. For example, as the distal end with the communication unit 150 may be blown off center by wind. If the distal end is more than one foot off center, in one embodiment, the base unit 110 automatically retracts the extendable member 120. This may prevent accidents and/or damage to the apparatus 100.

In one embodiment, the base member 110 includes two lasers that are aligned parallel with the extendable member 120 on either side of the extendible member 120. If the lasers reflect back to the base member based on intersection with the extendible member 120, this may signify that the extendible member is too far off center, and initiate a retraction. In another embodiment, at least one wire running from the distal end to the proximal end of the extendible member 120 is used to detect deformation. When the wire tension reaches a threshold, it indicates a bend force that is hazardous, and the extendible member 120 may automatically retract.

From the law enforcement vehicle, the officer may control various aspects of the apparatus 100 and communication unit 150 in particular based on controls located on or in communication with the base unit 110.

For example, the officer may speak into a microphone at the base member 110 or through a Bluetooth enabled microphone, and the officer's voice may be transmitted at the communication unit 150. The officer may instruct the driver to roll down his window and produce his license and registration.

Using the base controls, the officer may also shine a light on the face of the driver to gauge the driver's reaction or just to see the driver more clearly. This may help the officer detect if the driver appears to be under the influence of any drugs. In one embodiment, the officer may control the intensity and/or direction of the light independently from the rest of the communication unit 150 and extendable member 120.

In one embodiment, the light is used as a flash to take a picture of the driver, which is then stored in the database of the base unit 110 or in some other database that the base unit 110 or communication unit 150 communicates with. The driver's picture may be used to verify the driver's identity against associated with the driver that is already stored in a public driver database.

In another embodiment, the audio unit may not only allow the officer to speak to the driver, but also may allow the driver to speak with the officer.

The smell detection unit may detect the presence of alcohol or marijuana in one embodiment. For example, it may contain one or more passive alcohol sensors that can detect the presence of alcohol in the ambient air of the vehicle. In one embodiment, the passive sensors are located at the communication unit 150. In another embodiment, a small fan located inside the base member 110 or communication unit 150 forces air through a tube, such as the central lumen, from the distal end of the extendable member 120 to the proximal end, allowing the officer to smell the air coming out of a port in the base member and make a judgment on whether alcohol or marijuana may be present.

The communication unit 150 may further include a means, such as a clamp or a scanner compartment, for receiving the driver's license, registration, and/or proof of insurance. In one embodiment, these items are photographed or scanned by the communication unit 150, and made viewable at the base unit or some other screen in the police car.

Finally, in one embodiment, the police officer may hit a button that causes an electric charge to transmit down the extendable member 120 for the purpose of delivering a shock. For example, if the driver is belligerent and grabs the communication device 150 or extendable member 120 with the intent to cause damage, the officer may deliver a shock to the driver in States where this is permitted by law.

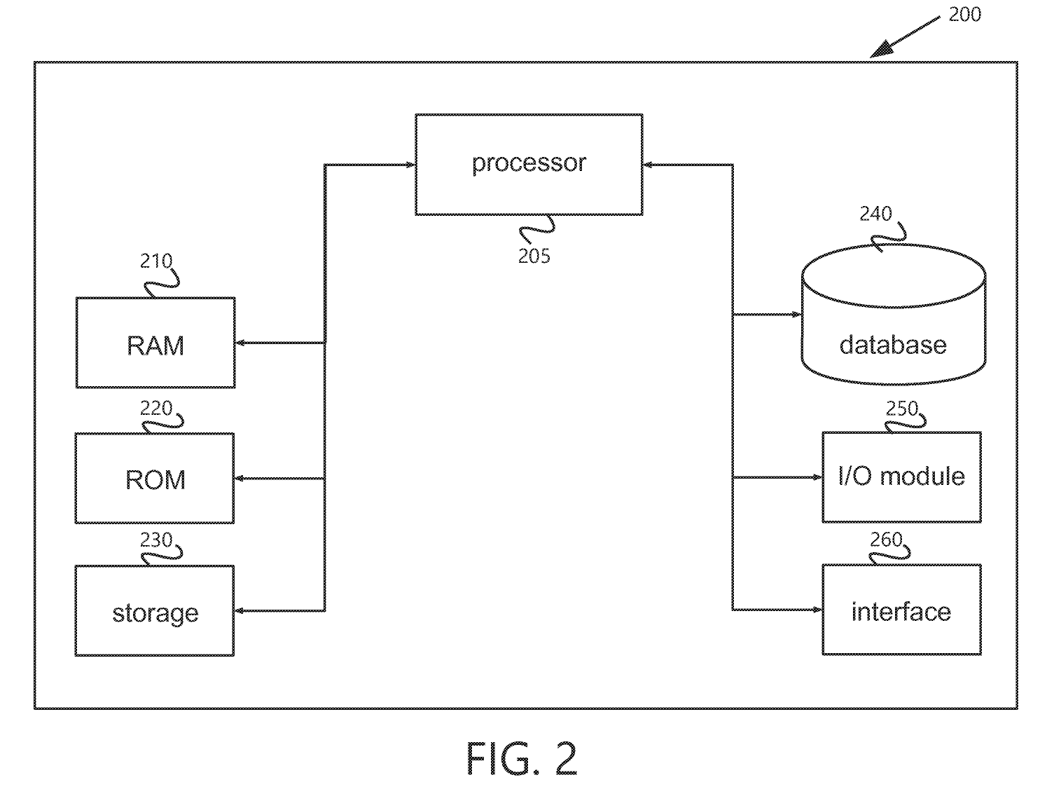

FIG. 2 depicts an exemplary processor-based computing system 200 representative of the type of computing system that may be present in or used in conjunction within the base member 110 and/or display apparatus 150. The computing system 200 is exemplary only and does not exclude the possibility of another processor- or controller-based system being used in or with one of the aforementioned components.

In one aspect, system 200 may include one or more hardware and/or software components configured to execute software programs, such as software for storing, processing, and analyzing data. For example, system 200 may include one or more hardware components such as, for example, processor 205, a random access memory (RAM) module 3210, a read-only memory (ROM) module 220, a storage system 230, a database 240, one or more input/output (I/O) modules 250, and an interface module 260. Alternatively and/or additionally, system 200 may include one or more software components such as, for example, a computer-readable medium including computer-executable instructions for performing methods consistent with certain disclosed embodiments. It is contemplated that one or more of the hardware components listed above may be implemented using software. For example, storage 230 may include a software partition associated with one or more other hardware components of system 200. System 200 may include additional, fewer, and/or different components than those listed above. It is understood that the components listed above are exemplary only and not intended to be limiting.

Processor 205 may include one or more processors, each configured to execute instructions and process data to perform one or more functions associated with system 200. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 2A, processor 205 may be communicatively coupled to RAM 210, ROM 220, storage 230, database 240, I/O module 250, and interface module 260. Processor 205 may be configured to execute sequences of computer program instructions to perform various processes, which will be described in detail below. The computer program instructions may be loaded into RAM for execution by processor 205.

RAM 210 and ROM 220 may each include one or more devices for storing information associated with an operation of system 200 and/or processor 205. For example, ROM 220 may include a memory device configured to access and store information associated with system 200, including information for identifying, initializing, and monitoring the operation of one or more components and subsystems of system 200. RAM 210 may include a memory device for storing data associated with one or more operations of processor 205. For example, ROM 220 may load instructions into RAM 210 for execution by processor 205.

Storage 230 may include any type of storage device configured to store information that processor 205 may need to perform processes consistent with the disclosed embodiments.

Database 240 may include one or more software and/or hardware components that cooperate to store, organize, sort, filter, and/or arrange data used by system 200 and/or processor 205. For example, database 240 may include information to that tracks driver information, license, and registrations for drivers that are ticketed using the apparatus 100. Alternatively, database 240 may store additional and/or different information. Database 240 may also contain a plurality of databases that are communicatively coupled to one another and/or processor 205, of may connect to further database over the network.

I/O module 250 may include one or more components configured to communicate information with a user associated with system 200. For example, I/O module 250 may include a console with an integrated keyboard and mouse to allow a user to input parameters associated with system 200, such as driver license and/or registration information. In one embodiment, the I/O module 250 allows the user to simply verify driver information that the communication unit 150 has scanned. I/O module 250 may also include a display including a graphical user interface (GUI) for outputting information on a monitor. I/O module 250 may also include peripheral devices such as, for example, a printer for printing information associated with system 200, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 260 may include one or more components configured to transmit and receive data via a communication network, such as the Internet, a local area network, a workstation peer-to-peer network, a direct link network, a wireless network, or any other suitable communication platform. For example, interface 260 may include one or more modulators, demodulators, multiplexers, demultiplexers, network communication devices, wireless devices, antennas, modems, and any other type of device configured to enable data communication via a communication network.

Turning to FIG. 3, another exemplary embodiment of an apparatus 100 including a base member 110 and extendable member 120 is shown. This view shows the gap 310 that may allow the base member 110 to straddle the top of the door in the window opening of the police car, for example, as shown in FIG. 1A. This may allow the apparatus 100 to be portable and not require special retrofitting of the police car. Additionally, inner pads 340 and 342 may provide extra grip for the base member 110 and prevent damage to the door. When the apparatus 100 is used in this manner, grip 320 may be placed in an upward position (as illustrated) so as not to interfere with the placement on the door. Controls, such as handle 315, may be present on the side of the base member present within the car in one embodiment. Additional buttons, not illustrated, may also be present.

In another embodiment, opening the door of the vehicle may cause the elongate member 120 to retract automatically into the base member, to prevent damage to the apparatus 100 or the car itself. In another embodiment, opening the door may cause the elongate member to swivel at the base member such that it will remain substantially parallel to the side of the car at the wheel well and not strike the car based on the angle of the open door. For example, the further the door is opened, the more the elongate member may swivel to maintain its substantially parallel position. This may be controlled by optical sensors or cameras on the elongate member in one embodiment that cause a processor in the apparatus to maintain an approximate distance from the side of the car, ensuring that the elongate member does not strike the car or overcorrect and point out into a roadway.

In one embodiment, the apparatus is portable and may be removed from the driver's side door of the law enforcement vehicle and placed on the passenger side door. This may allow a passenger to control the extendable apparatus. It also may allow for easier use of the apparatus when the law enforcement vehicle is positioned in front of the pulled over vehicle. For example, if the officer(s) pull over a tractor trailer, they could position the law enforcement vehicle in front of the tractor trailer so that the telescoping member will still reach the driver or passenger window of the tractor trailer.

In another embodiment, the officer may instead mount the apparatus 100 on his arm. In this configuration, the officer's arm rests within gap 310, and handle grip 320 may be pivoted downward and locked into place so that the officer may hold the grip 320 and steady the apparatus 100. With his other hand, the officer may use controls 315 to control the telescoping of the extendable member 120 and various functions of the communication unit 150.

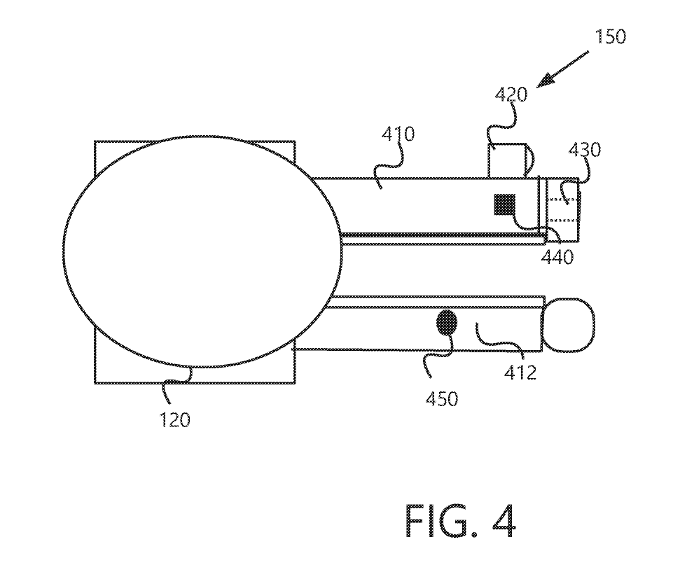

Turning to FIG. 4, an exemplary communication unit 150 is illustrated. The communication unit may be capable of rotating on the axis of the extendable member 120 in one embodiment, based on controls as the base member 110. In one embodiment, the communication unit may have two portions 410 and 412 that form an example item holding unit. The portions 410 and 420 can be pressed together to hold physical driving credentials such as a driver's license, registration, and/or insurance information. Additional components may be built into these portions.

Each portion may have padding at the end proximal to the driver's vehicle. This can help prevent damage should the communication unit 150 inadvertently contact the vehicle.

In one embodiment, the item holding unit is illuminated to allow the occupant to more easily place driving credentials into the item holding unit.

In another embodiment, the item holding unit includes a scanner on the top 410 or bottom portion 420 to allow the officer to see the credentials without retracting the extendable member 120.

In one embodiment, camera element 430 supplies the computer system with images that the computer system displays to the officer and also analyzes to assist the officer in better steering and positioning the communication unit 150. In one embodiment, the camera unit 430 may have an obstructed view path through a hole in the padding. The padding may protect the communication unit 150 and the camera unit 430 in particular.

In another embodiment, the camera unit 430 also includes a separate camera on the lower portion 412 that may face downward (not illustrated). The downward facing camera may send images to the computer system that allow the officer to ensure that the communication unit 150 is not crossing a lane line into traffic. In one aspect, the computer system actively monitors images from the downward facing camera to detect a lane line and insure the communication unit 150 stays away from the lane line. In one aspect, the computer system will disable further extension if it detects that the lane line is getting closer to the communication unit 150 and is less than one foot away. It may make this detection by using a processor to detect lines of at least two inches in width that have a high contrast with the surrounding surface. For example, this could allow for detection of white or yellow lines on a black or grey surface, or detection of black or grey lines on a white surface.

The light element 420 may be positioned behind the camera element and used to shine light at the driver. In another embodiment, an additional light may be on the lower portion 412 and oriented downward to illuminate the view of the downward facing camera.

Additionally, the smell detection unit 440 may also be present, as well as audio element 450. The smell detection unit 440 may include an air pump that sucks air into the unit from the surroundings. It also may include a Breathalyzer attachment in one embodiment, such that the officer may deliver a sanitized Breathalyzer mouthpiece for the occupant of the vehicle to attach to the Breathalyzer attachment. The occupant can then blow into the Breathalyzer.

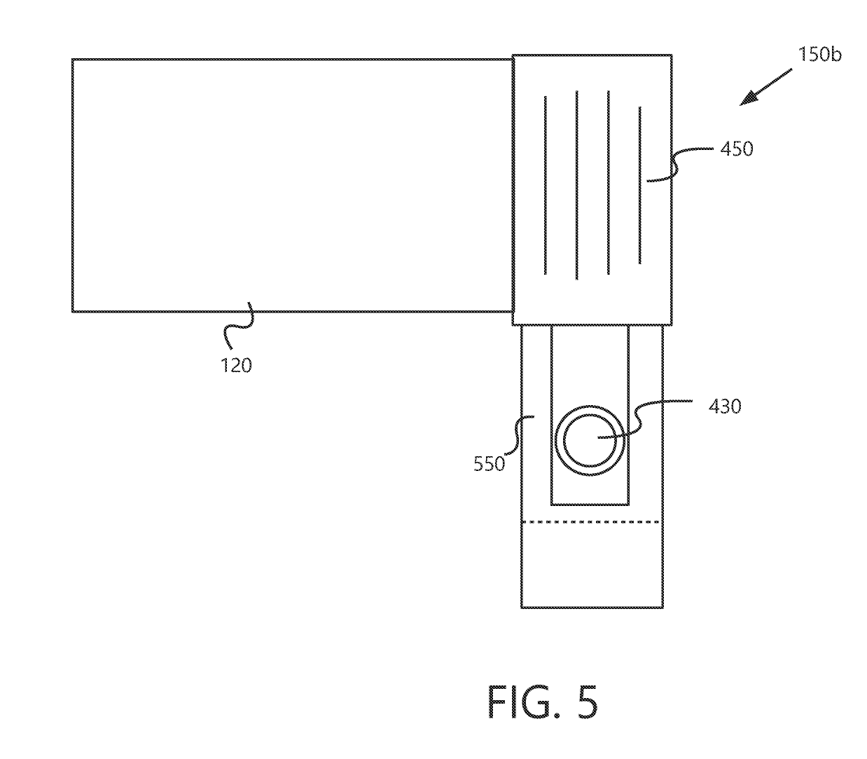

FIG. 5 presents an alternate example of a communication unit 150b. This example has a larger audio element 450 that allows for louder sound with a larger speaker.

Additionally, the clamping mechanism 550 for holding physical items is oriented downward and spring loaded.

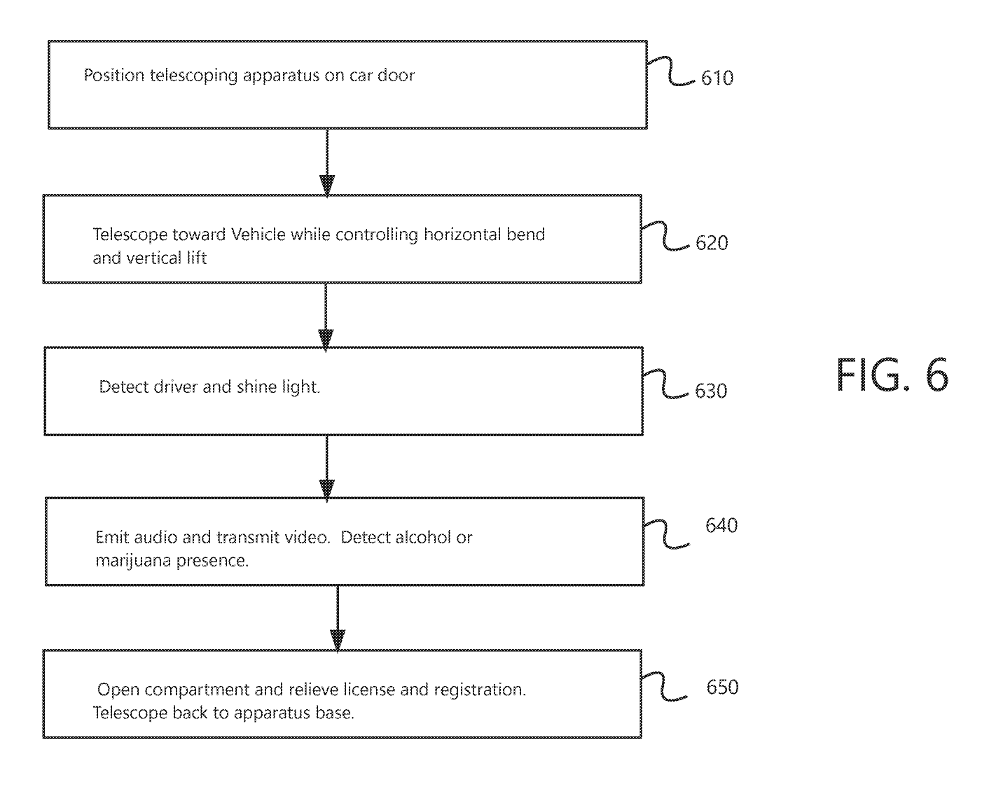

FIG. 6 is an example flow chart of steps included in a method according to an embodiment.

At step 610, the officer rolls down her window and places the telescoping apparatus on top of the door in the window opening, straddling the door.

At step 620, she controls the elongate extendible member to place it near the driver's side window of the pulled-over vehicle.

At step 630, the officer causes the communication unit to shine a light on the driver. In another embodiment, the apparatus recognizes the presence of a human face and automatically shines the light.

At step 640, the communications until transmits and receives audio (such as through a microphone), allowing the officer to converse with the driver. Detection of alcohol and marijuana is also attempted, both through passive sensors and through moving air to the proximal end for the officer to smell, in one embodiment.

At step 650, the driver places driver information into a compartment. This information is either scanned in the compartment, or the officer retracts the extendible member to retrieve it.

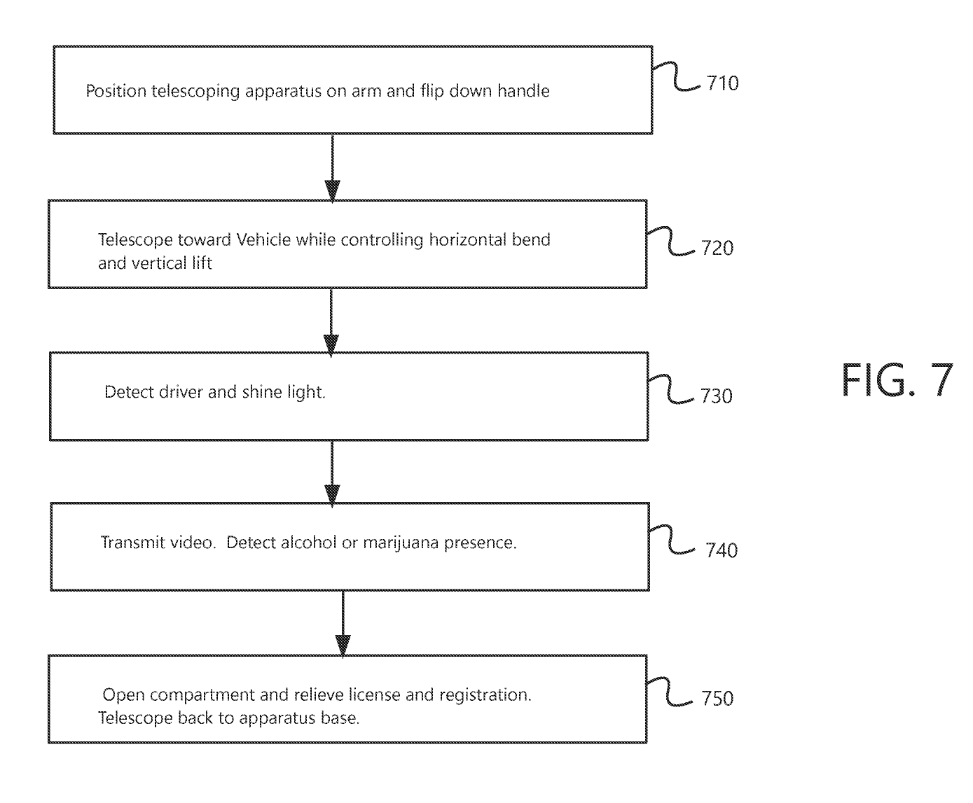

FIG. 7 is an example flow chart of steps included in a method according to an embodiment.

At step 710, the officer positions the telescoping apparatus onto his arm.

Steps 720 and 730 are similar to steps 620 and 630, respectively.

At step 740, the communications unit transmits video to a screen on the base member or elsewhere in the car.

Step 750 is similar to step 650.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A extendable ticketing apparatus, including:
a base member;
an elongate extendable member coupled to the base member, the elongate extendable member having at least two sections, a distal end, and a proximal end; and
a communication unit coupled to the distal end of the elongate extendible member, the communication unit including:
a camera element;
an audio element;
a lighting element;
an item holding element; and
a smell detection unit.

2. The extendable ticketing apparatus of claim 1, wherein the camera element detects the presence of a driver's side window opening, and slows extension of the elongate extendable member.

3. The extendable ticketing apparatus of claim 1, wherein the elongate extendable member can extend by telescoping such that the second section slides out of the first section.

4. The extendable ticketing apparatus of claim 1, wherein the audio element allows a user at the base member to converse with a driver at the distal end.

5. The extendable ticketing apparatus of claim 1, wherein the base member includes controls that allow a user to position the communication unit.

6. The extendable ticketing apparatus of claim 5, wherein the controls further allow the user to shine the lighting element at a driver's face and record video information from the camera element.

7. The extendable ticketing apparatus of claim 1, wherein the smell detection unit causes the base member to indicate a level of smell detection.

8. The extendable ticketing apparatus of claim 7, wherein the base member indicates potential detection of alcohol differently than marijuana.

9. The extendable ticketing apparatus of claim 1, wherein the smell detection unit includes a passageway down the elongate extendable member, wherein the passageway is connected to an output on the base member and a motorized fan for sucking air from the distal end to the proximal end.

10. A method for performing traffic citations from inside a police car, including:
placing an extendable apparatus on either the top of a door or on a user's arm such that a base member portion straddles either the door or the user's arm;
extending an elongate extendable member from the extendable apparatus, wherein the extendable member has a distal end and a proximal end, the distal end including a communication unit and the proximal end being attached to a base member;
stopping extension proximal to a driver's side window opening;
viewing a driver through use of a camera element at the communication unit to transmit video information to the base element;
speaking to the driver through the base element, wherein the audio is transmitted to the driver though an audio element at the communication unit; and
receiving physical driver credentials at the communication unit.

11. The method of claim 10, wherein receiving physical driver credentials at the communication unit includes taking a snapshot of the driver credentials by the communication unit, and transmitting the driver credentials to the base element.

12. The method of claim 10, further comprising retracting the elongate extendable member in response to receiving a button press at the communication unit after the driver has placed the physical driving credentials into the communication unit.

13. The method of claim 10, further comprising causing air to flow from the distal end to the proximal end through the elongate member.

14. The method of claim 10, further comprising printing a ticket at the communication unit.

15. A extendable ticketing apparatus, including:
a base member that has first and second sides coupled to a top, such that an open gap exists between the first and second sides;
an elongate extendable member coupled to the second side of the base member, the elongate extendable member having a distal end, and a proximal end, wherein the elongate member includes a sensor that communicates with a processor in the base member to maintain an approximate distance from a side of a vehicle; and
a communication unit coupled to the distal end of the elongate extendible member, the communication unit including a camera element.

16. The extendable ticketing apparatus of claim 15, further including a pivoting handle grip that swings into place for bracing the extendable ticketing apparatus on a human arm, and retracts for placing the extendable ticketing apparatus on a door of the vehicle.

17. The extendable ticketing apparatus of claim 15, wherein the elongate extendable member is at least partially made of a lightweight thermoplastic that includes a mix of glass and polymer fiber.

18. The extendable ticketing apparatus of claim 17, wherein the elongate extendable member includes at least three sections, wherein upon extension, a distal-most section is lighter than a proximal-most section, and wherein the proximal-most section is at last partially reinforced with a metallic material at the location where it is coupled to the base member.

19. The extendable ticketing apparatus of claim 18, wherein first and second sections of the at least three sections will decouple from one another upon receiving an impact force of greater than 60 lbs per square inch.

20. The extendable ticketing apparatus of claim 15, wherein the extendable member receives an electrical current along its exterior at the press of a button on the base member.
